(19) United States
(12) Patent Application Publication
(10) Pub. No.: US 2005/0108118 A1
(43) Pub. Date: May 19, 2005

(54) System and method for creation of a patent investment entity

(75) Inventors: James E. Malackowski, Chicago, IL (US); Andrew Carter, Glen Ellyn, IL (US); Mark Rubin, Riverwoods, IL (US)

Correspondence Address: FOLEY & LARDNER, 777 EAST WISCONSIN AVENUE, SUITE 3800, MILWAUKEE, WI, 53202-5308, US

(73) Assignee: ICMB Ocean Tomo

(21) Appl. No.: 10/718,041

(22) Filed: Nov. 18, 2003

(51) Int. Cl. G06F 17/60

(52) U.S. Cl. 705/30

(57) ABSTRACT

A method of utilizing an intellectual property grouping owned by a patent entity to generate income. The method includes acquiring rights in a first intellectual property asset from a seller on behalf of a patent investment entity, providing compensation to the seller in exchange for the first intellectual property asset, granting less than all of the rights in the first intellectual property asset to the seller of the intellectual property asset in exchange for a stream of payments, wherein granting less than all of the rights in the first intellectual property asset creates residual rights in the first intellectual property asset, and utilizing the residual rights in the first intellectual property asset to generate income for the patent investment entity.

### BACKGROUND

The present application relates to methods of securitizing and/or monetizing assets to obtain benefits associated with the transaction. In particular, the present application relates to methods of creating a patent investment entity to facilitate the securitizing and/or monetizing of intellectual property (IP) to obtain benefits associated with the securitizing and/or monetizing.

A securitization includes an assignable agreement having one or more specified future payments backed by rights sufficient to assure the parties purchasing the security that the payments will be made or title to property of similar value can be obtained. For example, in the case of a mortgage, the property interest is title to real estate. In the case of a sale/lease back, the property interest is the right of eviction. In the case of the securitization of intellectual property (IP) assets, discussed in more detail below, the property interest obtained in the event that the future payments are not made is the right to exclude others from the use of the subject matter of the IP. In each case, the party providing the capital has the ability to acquire a property interest that can be resold to others to provide a return on their original capital investment in the event that the specified future payments are not made according to the agreement.

Monetization may include the conversion of an asset or group of assets into some form of compensation, such as a lump sum payment, a stream of payments, etc. For example, licensing intellectual property in exchange for a stream of licensing payments monetizes the patent.

In the practice of accounting, it is well established that IP is “intangible property” that has no intrinsic value per se, but is merely representative of the value of the discovery. As an incentive for R&D expenditures, R&D costs are fully deductible as an expense in the year the costs are incurred. Therefore, when R&D expenditures result in IP such as a patent, the “book value” of the patent is zero even though the value to the business may be large. However, during an acquisition of an entity that owns IP assets, it may be required that the IP asset receive a book value that is equivalent to the fair market value of the IP assets. Further, wherein the intellectual property is sold to another entity, the value received for that sale is recognized.

Some intellectual properties created as a consequence of R&D possess desirable characteristics that lend themselves to securitization and/or monetization. Patents are one such intellectual property. Patents entitle the owner to exclude others from practicing the invention covered by the patent. Another type of intellectual property is information described in writings and knowledge arising within a business which is: (a) not generally known by others; (b) is retained in secret, and (c) is disclosed to others only under covenants to retain such disclosed intellectual properties secret between and among the parties bound by such covenants (hereinafter referred to as “trade secrets” or “know how”). Copyrights are another form of IP that may be securitized. Copyrights provide an author the right to control reproduction of his intellectual creation, such as literary works, musical works, dramatic works, pictorial works, motion pictures, sound recordings and architectural works.

A characteristic of intellectual property assets is the right to license, lease, or otherwise convey rights to use or otherwise practice the useful art, in whole or in part, embodied in such intellectual properties (hereinafter referred to as “licensing”). The granting of these rights to a third party is usually made in return for some type of compensation. A further characteristic of intellectual property assets is the right to identify potential infringers of the intellectual property asset and to request or sue for payment of a reasonable rate based on the infringing use.

What is needed is an entity configured to allow a corporation to obtain favorable benefits based on the sale of an intellectual property asset to a patent investment entity and subsequent leasing of the intellectual property asset from the patent investment entity. What is further needed is a patent investment entity configured to generate income based upon residual rights obtained in the acquisition and leasing of intellectual property assets.

### SUMMARY

One exemplary embodiment relates to a method of utilizing an intellectual property grouping owned by a patent entity to generate income. The method includes acquiring rights in a first intellectual property asset from a seller on behalf of a patent investment entity, providing compensation to the seller in exchange for the first intellectual property asset, granting less than all of the rights in the first intellectual property asset to the seller of the intellectual property asset in exchange for a stream of payments, wherein granting less than all of the rights in the first intellectual property asset creates residual rights in the first intellectual property asset, and utilizing the residual rights in the first intellectual property asset to generate income for the patent investment entity.

Another exemplary embodiment relates to a method of utilizing an intellectual property grouping owned by a patent entity to generate income. The method includes acquiring rights in a first and second intellectual property asset from at least one seller on behalf of a patent investment entity, providing compensation to each of the at least one seller in exchange for the first and second intellectual property assets, granting less than all of the rights in the first intellectual property asset to the sellers of the first and second intellectual property assets in exchange for a stream of payments, wherein granting less than all of the rights in the first and second intellectual property asset creates first and second residual rights in the first and second intellectual property assets, respectively, and utilizing the first and second residual rights in the first and second intellectual property asset to generate income for the patent investment entity

Yet another exemplary embodiment relates to a patent investment entity configured to manage an intellectual property grouping to generate income. The patent investment entity includes an intellectual property grouping, including at least one residual right in a first intellectual property asset, the first intellectual property right created by a grant of less than all of the rights in the first intellectual property asset in exchange for a stream of payments. The patent investment entity further includes at least one equity interest in the patent investment entity, the interest configured to represent an interest in income generated by the intellectual property grouping and an income distribution system, the system configured to distribute income generated by the intellectual property grouping.

Yet another exemplary embodiment relates to a method of structuring a transaction to acquire an intellectual property asset including an intellectual property right. The method includes acquiring a first portion of the intellectual property right from a seller in exchange for the fair market value of the first portion, acquiring a second portion of the intellectual property right from a seller in exchange for an equity interest in a patent investment entity, leasing the first portion of the intellectual property right to the seller for a predefined lease term, and utilizing the second portion of the intellectual property right as a source of income for the patent investment entity.

Yet another exemplary embodiment relates to a method of structuring a transaction to acquire an intellectual property asset including an intellectual property right. The method includes acquiring a first portion of the intellectual property right from a seller in exchange for the fair market value of the first portion, acquiring a second portion of the intellectual property right from a seller in exchange for an equity interest in a patent investment entity, leasing the first portion of the intellectual property right to the seller for a predefined lease term, and utilizing the second portion of the intellectual property right in combination with at least one second portion from at least one second intellectual property asset as a source of income for the patent investment entity.

### BRIEF DESCRIPTION OF THE DRAWINGS

FIG. 1 is a block diagram illustrates a system and method for monetizing and/or securitizing intellectual property using a patent investment entity including acquired intellectual property assets according to an exemplary embodiment;

FIG. 2 is a block diagram illustrating a system and method for monetizing and/or securitizing intellectual property using a patent investment entity including acquired intellectual property assets according to an alternative embodiment; and

FIG. 3 is a block diagram illustrating a system and method for grouping intellectual property rights according to an exemplary embodiment.

### DETAILED DESCRIPTION OF THE PREFERRED EMBODIMENTS

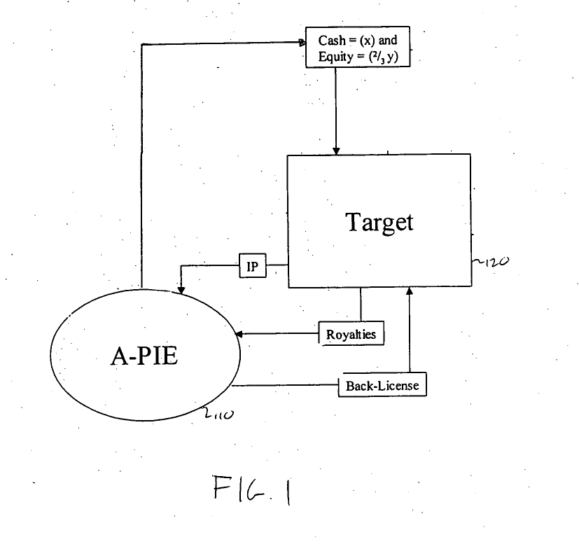

Referring now to FIG. 1, a block diagram 100 illustrates a system and method for monetizing and/or securitizing intellectual property using a patent investment entity including acquired intellectual property (“IP”) assets according to an exemplary embodiment. Block diagram 100 includes a patent investment entity 110 and a target entity 120 owning one or more IP assets.

Target entity 120 may be any type of entity owning or owning rights in one or more IP assets. For example, target entity 120 may be a corporation, a partnership, an individual, etc.

The ownership of the one or more IP assets may be ownership based on creation, for example where a person within target entity 120 creates an invention and obtains a patent directed to the invention or creates an original work and obtains a copyright. Alternatively, ownership may be the result of an acquisition of an IP asset originally owned by another entity. Further, ownership may be based on an acquisition by licensing of an IP asset owned by another. Yet further, the ownership may be ownership in whole or in part. Ownership of an IP asset can include any type of ownership that confers the right to exercise one or more IP rights associated with the IP asset. Examples of IP assets may include patents, copyrights, trade secrets, trademarks, etc.

IP rights can include any right associated with an IP asset. An IP right may be conferred by statute, case law, practice in the industry, inherent properties, etc. An IP right may further include the right to perform an action and/or prevent another party from performing an action. For example, patents entitle the owner to exclude others from importing, making, using, selling, or offering to sell the invention covered by the patent. Further, copyrights provide an author the right to control reproduction of his intellectual creation, such as literary works, musical works, dramatic works, pictorial works, motion pictures, sound recordings and architectural works, along with the right to make derivative works.

According to an exemplary embodiment, and based on the nature of IP rights, it is often possible to split an IP right into one or more portions of the IP right. For example, as stated above, a patent generally includes a right to exclude others from practicing the invention. Inherent in the right to exclude is the right to license particular entities to practice the invention, usually in return for compensation, such as licensing fees. Further, different type of licenses may be granted such as an exclusive license, a non-exclusive license, an exclusive license within a defined field of use, etc. Whenever the license is other than an exclusive license to all fields of use for the entire economic life of the underlying IP asset, residual rights in the IP asset are created and licenses based on the residual rights may be granted to additional entities. Each portion of the IP right includes a right under the IP asset that is less than all of the rights afforded by the “P asset.

Target entity 120 may be configured such that the entity is only utilizing a first portion of the IP rights afforded under an IP asset. For example, when a target entity 120 is a vehicle manufacturer and owns a patent directed to a method of spray painting, the vehicle manufacturer may only be utilizing the patented method of spray painting as applied to vehicles. Accordingly, the first portion of the IP right is a right to exclude others from using the method of spray painting to spray paint vehicles. The first portion may be either an exclusive or a non-exclusive right. The first portion may further be a right to use the subject matter of the IP asset.

However, the patent right also includes at least a second portion of the IP right, which may include, continuing with the earlier example, the method of spray painting as applied to houses. The at least second portion may be referred to as a residual portion. The residual portion may not be utilized by the vehicle manufacturer because they have no interest in preventing others from using this method to spray paint houses. The IP right residual portions may include numerous residual portion delineated by field of use, term of use, geographic location of use, etc.

The residual portion of the IP right, although not valuable to the target entity 120 in its present business, may be valuable to another entity in a different business, such as house painting. Accordingly, the house painting entity may desire to license the residual portion or any portion thereof of the IP right. Further, there may be infringers of the residual portion of the IP right. It may be possible to obtain reasonable royalties based on the infringing use by the infringers.

However, target entity 120 may not possess the resources or knowledge required to capture the potential income that may be generated based on the residual portion of the IP right. For example, patent litigation is a costly venture and a relatively small target entity may not have the resources to pursue this course of action, especially against an entity that is not a competitor. Further, licensing revenue can only be generated if the target entity 120 is able to identify potential licensees. Identifying potential licensees may require in depth analysis of IP rights and markets where the IP rights may be of value. This type of analysis may require a diverse and specialized knowledge base.

Accordingly, target entity 120 may enter into a transaction wherein target entity 120 is able to continue to utilize the first portion of the IP right and also capture the additional income potential of the residual portion of the IP right. The transaction may include the sale of IP assets from the target entity 120 to patent investment entity 110, and the subsequent transfer of just the first portion of the IP rights back from patent investment entity 110 to the target entity 120.

In order to begin the process, at least one IP asset must be identified. Generally, an owner that wishes to securitize some portion of its IP portfolio will identify all IP assets it owns, and determine which ones it wishes to have analyzed for securitization and/or monetization. Often, the owner will want to securitize all the IP assets it owns that relate to a particular product line or business activity. The IP portfolio may even contain IP assets owned by third parties, so long as the owner seeking securitization and/or monetization has exclusive rights in such third party IP assets, and the right to convey such exclusive rights to others.

Once a particular IP portfolio is identified, its current value must be determined to an acceptable degree of accuracy for purposes of securitization and/or monetization, further described below. The number of different approaches to determining value of the IP estate is virtually limitless, and different methods will produce different estimated values. One method, described below, is described in U.S. patent application No. 20010042034, filed Jan. 11, 2001.

To effectively securitize and/or monetize an IP asset, an economically reasonable estimate of the current value of the IP must be obtained as described above. Further, the ability to demonstrate to a current owner the value of an IP for which the owner is seeking securitization is useful. While numerous methods of estimating the value of one or more intellectual properties are known, the invention disclosed herein includes a method of combining an estimate of the value of an IP with an assessment of the impact on the value of the selling business of securitizing and/or monetizing that IP. This method comprises entering information related to at least one IP, calculating a value of the at least one IP using a first valuation algorithm, selecting a second valuation algorithm having a plurality of inputs, inputting the value of at least one IP into the second valuation algorithm, inputting at least one additional piece of information required by the second valuation algorithm, and calculating the change in value to the owner of the IP using the second valuation algorithm. The method may further comprise inputting an identifier indicative of a utility of the IP by selecting from a list including such options as: “new product category,” “improvement on an existing product,” “a new process,” “an improvement on an existing process,” and “regulatory compliance.” The method may further comprise selecting a first valuation algorithm from a plurality of valuation algorithms by selecting a first valuation algorithm particular to the type of utility associated with the IP. The method may further comprise entering information on the financial characteristics of the owner not directly related to the IP asset.

Typical information used for the valuation method of this invention includes, but is not limited to: current and projected future revenues and costs of the goods covered by the IP asset, cost savings attributable to an invention covered by an IP asset, the book value of the business activities associated with the IP asset, and ongoing expenditures for marketing, research and development. It is difficult to calculate a value for an IP asset not associated with any current or ongoing revenue or costs.

The particular valuation algorithm will necessarily determine what information must be obtained and entered for the valuation to be completed. For example, when making a valuation for an environmental control invention that permits a business to continue operation under regulatory requirements, the evaluation should take into consideration the ongoing revenue generated by the continuation of the business. In addition to financial information, information such as the remaining life of the patent may be used by the first valuation algorithm.

Once the appropriate first valuation algorithm has been determined for each IP asset within a portfolio, the current value of the portfolio is determined using the appropriate algorithms.

Determining whether an owner should securitize or monetize its selected IP portfolio, or a portion thereof, will depend on a number of factors in addition to the estimated value of the IP portfolio. Therefore, the second valuation algorithm may have at least one other input in addition to the valuation of the IP portfolio obtained from the first algorithm. For example, an owner typically will not securitize or monetize its IP portfolio if the original owner is required to make a future payment stream to a third party that is greater than the owner's return on equity or the monetization would result in a loss. Therefore, in addition to determining the current value of the IP portfolio, the change in value to the original owner of the IP portfolio may be considered when selecting a second valuation algorithm.

The current value of the IP portfolio may be used as a starting point to determine the value at which the portfolio is securitized. Therefore, the estimated current value is used by a second valuation algorithm.

Once the appropriate second valuation algorithm is selected, the appropriate information is collected and entered. For example, securitization or monetization may involve an exchange of the IP portfolio for compensation, such as a lump sum payment, a stream of income, a contractual right, an equity interest, etc., to the original owner. The future value to the original owner of the net proceeds of the compensation may also be considered in the second valuation algorithm. One measure of the future value of the net proceeds of the compensation to the original owner is the current return on equity. Other measures, such as money market rates or the prime rate, may also be used.

The second valuation algorithm may determine the change in value to the original owner if the IP portfolio is securitized and/or monetized, versus the value to the original owner if the portfolio is not securitized and/or monetized. This outcome will be used to decide whether to securitize or moentize the IP portfolio. If the value is positive, the business will show an increase in value in that amount if the IP portfolio is securitized and/or monetized. Once a positive change in the value of the business based on this calculation has been determined, the IP portfolio will probably be securitized and/or monetized for an amount related to, but not identical to, the estimated current value. For example, if the estimated current value is $370,180,000, the portfolio may be securitized on monetized for $350,000,000, $370,000,000, or other amounts in a similar or lesser range, but would probably not be securitized and/or monetized for an amount of $500,000,000.

The valuation is utilized in the acquisition of the IP assets by patent investment entity 110. Patent investment entity 110 may be any type of entity, such as a corporation, a partnership, etc. Patent investment entity 110 is configured to acquire IP assets from target entity 120. Patent investment entity 110 may further be configured such that equity interests in patent investment entity 110 may be issued. The equity interests may be based, at least in part, on the income generated by patent investment entity 110 in the securitization and/or monetization of the acquired IP assets acquired by patent investment entity 110. Although generation of income is described, a loss may occur within the generation of income.

According to an exemplary embodiment, as shown in FIG. 1, IP assets may be acquired by patent investment entity 110 from target entity 120 in exchange for some type of compensation, such as cash payments, contractual rights, equity interests in patent investment entity 110, etc. According to an exemplary embodiment, the acquisition of an IP asset by patent investment entity 110 from target entity 120 may be associated with a cash payment from patent investment entity 110 to target entity 120 based on the fair market value of the first portion of the IP right and an equity interest payment based on a percentage of the fair market value of the residual portion of the IP right. The percentage of the fair market value for the residual portion of the IP right may be a negotiated value determined to compensate target entity 110 for providing the residual portion of the IP right.

Following the transfer of ownership of the IP assets to patent investment entity 110, patent investment entity 110 may lease the first portion of the IP right back to target entity 110 such that target entity 110 may continue to exercise the right afforded by the first portion. Generally, the lease will allow target entity 110 to exercise the IP right for the duration of a lease term associated with the lease. In order to qualify as a true lease, the lease may be structured such that the value of the first portion of the IP right at the end of the lease term is at least 20% of the economic value of the first portion of the IP right at the beginning of lease term. One way to accomplish this is to limit the duration of the lease term to no more than eighty percent of the remaining economic life of the IP asset at the beginning of the lease.

In addition, wherein the patent investment entity 110 owns second portions from at least one additional IP asset, as will be further described below, patent investment entity may lease a right based on some or all of the second portions from the at least one additional IP asset, as well as the second portion for the IP asset obtained from the seller.

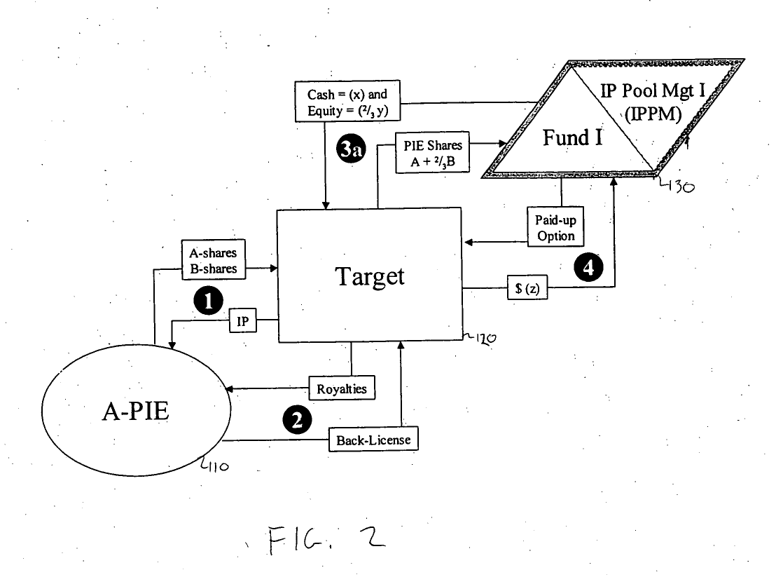

According to alternative embodiments, the acquisition of the IP assets by patent investment entity 110 from target entity 120 may be structured according to any other method that results in the acquisition of the IP asset by patent entity 120. For example, as shown in FIG. 2, transfer of the IP asset can include the transfer of equity in patent investment entity 110 to a fund entity 130 through target entity 120. Advantageously, different structures and/or entities may be utilized to facilitate financing, tax treatment, debt structure, distribution of income, etc.

According to an exemplary embodiment, patent investment entity 110 may securitize or monetize the IP asset. Securitization and/or monetization may include: selling of equity interests in the patent investment entity 110; utilizing acquired IP assets to generate a stream of income, for example through licensing, royalties, litigation, etc.; and allocating payments from the income stream to more than one investor, in varying proportions dependent on the investors equity interest.

The method of allocating payments to each one of multiple investors includes the steps of: (a) creating and identifying investor accounts, (b) obtaining an initial amount from an investor in exchange for an assignable agreement to allocate a proportionate amount of future income to the investors, (c) associating the initial amount from an investor with that investor's account, (d) for each IP asset to be securitized, identifying the initial owner of the IP asset, (e) paying an amount to the initial owner of the IP asset upon the transfer of title to the IP asset from the initial owner to one or more subsequent owners, (f) leasing a license to the initial owner and/or other entities for the use of the invention covered by the IP asset from the subsequent owner(s) in exchange for an agreement by the initial owner and/or other entity to make at least one payment in a predetermined amount at a specified time for the grant of such license, wherein the licenses can be of varying scope as to rights granted or fields of use, (g) obtaining at least one lease payment from the licensee(s) of the IP asset, (h) placing the at least one lease payment into fund 130 established for the purpose of receiving such funds, and (i) allocating the at least one lease payment from fund 130 to the respective investor account(s) in correct proportions.

The method may also be applied in the situation where a particular IP asset is already licensed to a user other than the owner prior to securitization of the IP asset. In such case, the IP asset may be acquired from the current owner, subject to the existing license obligation, so long as the existing license is consistent with the method disclosed herein. Alternatively, the method described herein may be applied independently of such license, so long as the license back to the initial owner is broad enough to encompass the existing license. Thus, the method would not be directly applicable in the situation where an IP asset owner had granted an exclusive license of all the rights granted by the IP asset unless the licensee also participated and agreed to enter a new license in accordance with the method disclosed herein.

Although the method can be applied in the situation where there is only one investor, a more typical situation will involve multiple investors. In that situation, each investor has a separate account and can separately sell their interest, or a portion thereof, to subsequent investors or redeem their interest or a portion thereof for cash payments. Therefore, the system must be able to create and track multiple investor accounts.

To permit the management of a portfolio of securitized patents with the ability to include new investors and permit existing investors to transfer or withdraw their interests, a computer system may be necessary. The system must be capable of handling multiple IP portfolios, multiple investor accounts, and the numerous transactions whereby investor interests in the various IP portfolios are made, changed, or terminated. Additionally, the system must be capable of handling repeated securitization and/or monetization of multiple IP assets and facilitate investments that are not time-dependent upon or specifically tied to individual underlying securitizing and/or monetization transactions.

Specifically, a system which permits the collection of investments from multiple investors, the real-time continuous evaluation of the value of the underlying IP assets, and which permits individual investors to increase their investment or to withdraw invested funds without requiring the underlying transaction to occur simultaneously with such change in investment is desirable for the ready securitization of IP assets.

Such a system may have the following general attributes, not all of which are essential: it would involve more than one underlying IP asset securitizing or monetizing transaction; it would permit one or more investors to invest funds in the system, where such investment was not associated with any particular IP asset securitizing or monetizing transaction; it would include the availability of funds not invested in IP assets for cash withdrawal, if needed; it would permit the securitizing and/or monetizing of additional IP assets using existing investment funds, rather than requiring additional investment for the new IP to be securitized and/or monetized; it would permit each individual investor's current investment to be evaluated on a regular basis; and would permit individual investors to withdraw funds independent of securitizing or monetizing transactions.

The computer system may be further configured to manage and/or implement the functionality described herein as being performed by patent investment entity 110. For example, the system may include an income distribution system configured to manage the distribution of income generated by the residual rights.

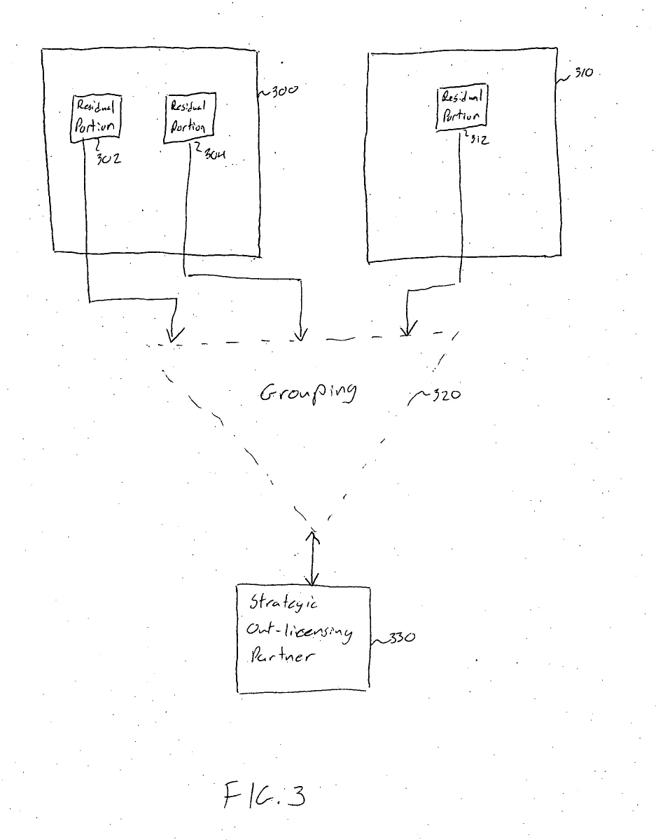

Referring now to FIG. 3, a block diagram illustrates entity involved in the creation of a grouping of IP rights. The grouping may involve the contribution of IP rights from one or more entities.

For example, FIG. 3 shows the a first patent investment entity 300 contributing a first residual right 302 and a second residual right 304 to a grouping 320. One or more entities may contributed IP rights to grouping 320. Second patent investment entity 310 contributes a third residual right 312 to grouping 320. Each patent grouping may be associated with a specific strategic out-licensing partner 330, as further described below.

The residual portion of IP rights obtained from target entity 120, shown in FIG. 1, may further be grouped with other residual portions acquired from the acquisition of other IP assets. According to an exemplary embodiment, grouping may include acquiring multiple residual portions of an IP right within a single patent investment entity 110. The grouping may further rights contributed from other sources, such as a target entity 120.

Advantageously, the grouping of residual portions of IP rights 320 allows the patent investment entity 110 to create value from of the residual portions that would otherwise be wasted. The residual portions may be acquired based on at least one common characteristic of the residual portions. The common characteristic may include a technology area, a typical usage, a specific industry, etc.

Grouping of patent rights may facilitate economies of scale in the exercise of patent rights. For example, patent investment entity 110 is specifically configured for the exercise of patent rights. Accordingly, the patent investment entity 110 may have greater resources and/or more experience to obtain income based on the residual rights. Income may be obtained in the identification of potential licensees, pursuit of litigation against infringers, etc.

Additionally, the grouping 320 may be further structured such that any entity that provided an IP asset used in the grouping may be entitled to avoid infringement when practicing according to any other IP asset in the grouping. This benefit may be provided through licenses, covenants not to sue, etc.

For example, multiple residual portions may be grouped related to a single technology to strengthen a licensing bargaining position of the patent investment entity 110. When approaching a potential licensee, it may be advantageous be able to offer licenses to multiple residual portions within the potential licensee's field of operations. Advantageously, obtaining a single license has the effect of streamlining infringement avoidance for the potential licensee.

Grouping residual portions of IP rights may further facilitate recognition of additional opportunities to obtain IP assets. For example, it may be possible to identify a new IP asset based on the grouping of the residual portions and to obtain the IP asset based on the identification. For example, where the claims of two patents, viewed in concert, define a gap and identify a novel concept, a new patent application, or bridge patent, may be filed based on the novel concept.

Further each group may be associated with strategic out-licensing partner 330. Each strategic out licensing partner 330 may be specifically experienced in the area of technology or focus of the group of residual portions. Advantageously, the strategic out-licensing partners 330 may be experienced in the industry and in IP to facilitate identification of potential licensees, identification of bridge patent opportunities, etc.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A method of utilizing an intellectual property grouping owned by a patent entity to generate income, comprising
acquiring rights in a first intellectual property asset from a seller on behalf of a patent investment entity;
providing compensation to the seller in exchange for the first intellectual property asset;
granting less than all of the rights in the first intellectual property asset to the seller of the intellectual property asset in exchange for a stream of payments, wherein granting less than all of the rights in the first intellectual property asset creates residual rights in the first intellectual property asset; and
utilizing the residual rights in the first intellectual property asset to generate income for the patent investment entity.

2. The method of claim 1, wherein providing compensation to the seller in exchange for the first intellectual property asset includes acquiring all substantial rights of value in the first intellectual property asset.

3. The method of claim 1, further including providing compensation to the seller in exchange for at least a second intellectual property asset and grouping residual rights from the second intellectual property asset with the residual rights in the first intellectual property asset.

4. The method of claim 1, wherein providing compensation to the seller in exchange for the first intellectual property asset includes providing an interest in the patent investment entity.

5. The method of claim 4, further including distributing the generated income based upon the interests in the patent investment entity.

6. The method of claim 1, wherein providing compensation to the seller in exchange for the first intellectual property asset includes providing cash equivalent to the fair market value of the intellectual property asset.

7. The method of claim 1, further including analyzing the residual rights in the first intellectual property asset to identify a new intellectual property asset.

8. The method of claim 1, wherein the residual rights in the first intellectual property asset is grouped according to at least one common characteristic.

9. The method of claim 7, wherein the common characteristic is a field of technology.

10. The method of claim 1, further including offering an equity interest in the patent investment entity to at least one third party.

11. A method of utilizing an intellectual property grouping owned by a patent entity to generate income, comprising
acquiring rights in a first and second intellectual property asset from at least one seller on behalf of a patent investment entity;
providing compensation to each of the at least one seller in exchange for the first and second intellectual property assets;
granting less than all of the rights in the first intellectual property asset to the sellers of the first and second intellectual property assets in exchange for a stream of payments, wherein granting less than all of the rights in the first and second intellectual property asset creates first and second residual rights in the first and second intellectual property assets, respectively; and
utilizing the first and second residual rights in the first and second intellectual property asset to generate income for the patent investment entity.

12. The method of claim 11, wherein providing compensation to the seller in exchange for the first and second intellectual property assets includes acquiring all substantial rights of value in the first and second intellectual property assets.

13. The method of claim 11, further including providing compensation to the seller in exchange for at least a third intellectual property asset and grouping residual rights from the third intellectual property asset with the first and second residual rights.

14. The method of claim 11, wherein providing compensation to the at least one seller in exchange for the first and second intellectual property asset includes providing an interest in the patent investment entity to each seller.

15. The method of claim 14, further including distributing the generated income based upon the interests in the patent investment entity.

16. The method of claim 11, wherein providing compensation to the seller in exchange for the first and second intellectual property assets includes providing cash equivalent to the fair market value of the first and second intellectual property assets.

17. The method of claim 11, further including analyzing the first and second residual rights in the first and second intellectual property asset to identify a new intellectual property asset.

18. The method of claim 11, wherein the first and second residual rights in the first and second intellectual property assets are grouped according to at least one common characteristic.

19. The method of claim 18, wherein the common characteristic is a field of technology.

20. The method of claim 11, further including offering an equity interest in the patent investment entity to at least one third party.

21. A patent investment entity configured to manage an intellectual property grouping to generate income, comprising
an intellectual property grouping, including
at least one residual right in a first intellectual property asset, the first intellectual property right created by a grant of less than all of the rights in the first intellectual property asset in exchange for a stream of payments;
at least one equity interest in the patent investment entity, the interest configured to represent an interest in income generated by the intellectual property grouping; and
an income distribution system, the system configured to distribute income generated by the intellectual property grouping.

22. The patent investment entity of claim 21, wherein the intellectual property grouping further includes at least a residual right from a second intellectual property asset with the residual right in the first intellectual property asset.

23. The patent investment entity of claim 21, intellectual property grouping is created based on the exchange of at least one equity interest for the first intellectual property asset.

24. The patent investment entity of claim 23, further including a distribution system configured to distribute the generated income based upon the equity interests in the patent investment entity.

25. A method of structuring a transaction to acquire an intellectual property asset including an intellectual property right, comprising
acquiring a first portion of the intellectual property right from a seller in exchange for the fair market value of the first portion;
acquiring a second portion of the intellectual property right from a seller in exchange for an equity interest in a patent investment entity;
leasing the first portion of the intellectual property right to the seller for a predefined lease term; and
utilizing the second portion of the intellectual property right as a source of income for the patent investment entity.

26. The method of claim 25, wherein the intellectual property asset is a patent and wherein the right is a right associated with a patent.

27. The method of claim 26, wherein the first portion of the intellectual property right is a license.

28. The method of claim 25, wherein the amount of the equity interest in the patent investment entity is based on the appraised value of the second portion of the intellectual property right for licensing.

29. The method of claim 25, wherein leasing the first portion of the intellectual property right includes granting an exclusive license within a defined field of use.

30. The method of claim 25, wherein the predefined lease term is a term defined to be based on 80% of the economic life of the intellectual property asset.

31. The method of claim 30, further including providing the seller with an option to acquire the first portion of the IP right at the expiration of the predefined lease term.

32. The method of claim 25, wherein utilizing the second portion of the IP right as a source of income for the patent investment entity includes licensing the second portion of the IP right to a third party.

33. The method of claim 25, wherein utilizing the second portion of the IP right as a source of income for the patent investment entity includes identifying potential infringers of the IP asset.

34. A method of structuring a transaction to acquire an intellectual property asset including an intellectual property right, comprising
acquiring a first portion of the intellectual property right from a seller in exchange for the fair market value of the first portion;
acquiring a second portion of the intellectual property right from a seller in exchange for an equity interest in a patent investment entity;
leasing the first portion of the intellectual property right to the seller for a predefined lease term; and
utilizing the second portion of the intellectual property right in combination with at least one second portion from at least one second intellectual property asset as a source of income for the patent investment entity.

35. The method of claim 34, wherein the intellectual property asset is a patent and wherein the right is a right associated with a patent.

36. The method of claim 35, wherein the first portion of the intellectual property right is a license.

37. The method of claim 34, wherein the amount of the equity interest in the patent investment entity is based on the appraised value of the second portion of the intellectual property right for licensing.

38. The method of claim 34, wherein leasing the first portion of the intellectual property right includes granting an exclusive license within a defined field of use.

39. The method of claim 34, wherein the predefined lease term is a term defined to be based on 80% of the economic life of the intellectual property asset.

40. The method of claim 39, further including providing the seller with an option to acquire the first portion of the IP right at the expiration of the predefined lease term.

41. The method of claim 34, wherein utilizing the second portion of the IP right as a source of income for the patent investment entity includes licensing the second portion of the IP right to a third party.

42. The method of claim 34, wherein utilizing the second portion of the IP right as a source of income for the patent investment entity includes identifying potential infringers of the IP asset.
